(19) United States
(12) Patent Application Publication
(10) Pub. No.: US 2017/0369343 A1
(43) Pub. Date: Dec. 28, 2017

(54) WASTEWATER FILTER

(71) Applicant: COLGATE-PALMOLIVE COMPANY, New York, NY (US)

(72) Inventors: Frank Hom, Wayne, NJ (US); Michael Paul Robinson, II, Brooklyn, NY (US)

(21) Appl. No.: 15/191,012

(22) Filed: Jun. 23, 2016

(51) Int. Cl. C02F 1/52; B01D 35/28; B01D 39/16; C02F 1/00

(52) U.S. Cl. CPC C02F 1/52; C02F 1/001; B01D 35/28; B01D 39/1669; B01D 2239/0478

(57) ABSTRACT

A flocculation filter is provided. The flocculation filter includes a filter layer having openings that pass water and trap flocs is provided. The flocculation filter also includes a flocculant layer disposed on at least a portion of the filter layer.

### CROSS-REFERENCE TO RELATED APPLICATIONS

This application is related to application Ser. No. ______ filed ______ titled, “Bucket for Wastewater Filtration” (Attny. Dkt. No. 11131-00-US-01-HCP), the disclosure of which is incorporated herein by reference in its entirety.

### BACKGROUND

Filtration of wastewater involves causing small, suspended particles to cluster together and settle. This process includes two steps, namely “coagulation” and “flocculation.” “Coagulation” refers to driving together of colloidal particles by chemical forces. “Flocculation” refers to assembling the coagulated particles into clumped masses, called “flocs,” which settle out of the wastewater. Flocculation may use a chemical-bridging mechanism, enhanced by the use of substances like polyelectrolytes.

Wastewater filtration systems are widely used in public sanitation and industrial enterprises. However, residential use of such systems is generally limited to applications such as clarifying water in ponds, swimming pools, and the like.

### BRIEF SUMMARY

Implementations consistent with the present disclosure provide a flocculation filter including a filter layer having openings that pass water and trap flocs. The flocculation filter also includes a flocculant layer disposed on at least a portion of the filter layer. In some implementations the flocculation filter includes a water-soluble layer disposed on the flocculant layer. The filter layer can be a woven material or a non-woven material. The filter layer can also be a flexible material or a rigid material. The openings can range in size from about 0.03 inches to about 0.25 inches across.

In some implementations the filter layer forms a vessel including a sidewall, a closed bottom, and an open top. An edge of the sidewall at the open top can include includes a coupler. The coupler can be a drawstring or an elastic band captured in a tubular channel formed from the sidewall. The coupler can also be a rigid collar having mechanical interlocking elements. The mechanical interlocking elements can be threads or L-shaped slots. The mechanical interlocking elements can also be snap-fit couplers.

In some implementations the filter layer includes an interior wall and an exterior wall separated by a distance defining a space. The distance between the interior wall and the exterior wall can be between about one-quarter inch to about one-half inch. The space can be filled with a mesh material and the mesh material can be the flocculant layer coated or impregnated with a flocculant.

In some implementations the flocculation filter includes a frame having a substantially flat shape supporting the filter layer. The frame can be rectangular, circular, or toroidal.

Further areas of applicability of the present invention will become apparent from the detailed description provided hereinafter. It should be understood that the detailed description and specific examples, while indicating some preferred aspects of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A illustrates a side perspective view of a flocculation filter in accordance with aspects of the present disclosure;

FIG. 1B illustrates a sectional side view of a wall of an exemplary flocculation filter in accordance with aspects of the present disclosure;

FIG. 2 illustrates a side perspective view of an exemplary flocculation filter in accordance with aspects of the present disclosure;

FIG. 3 illustrates a side perspective view of an exemplary flocculation filter in accordance with aspects of the present disclosure;

FIG. 4 illustrates a side perspective view of an exemplary flocculation filter in accordance with aspects of the present disclosure; and

FIG. 5 illustrates a side perspective view of an exemplary flocculation filter in accordance with aspects of the present disclosure.

### DETAILED DESCRIPTION

The following description of various preferred aspects is merely exemplary in nature and is in no way intended to limit the invention, its application, or uses.

As used throughout, ranges are used as shorthand for describing each and every value that is within the range, as well as the endpoints of the range. Any value within the range can be selected as the terminus of the range. In the event of a conflict in a definition in the present disclosure and that of a cited reference, the present disclosure controls.

The present disclosure is generally directed to flocculation and, more specifically, to hand-portable flocculation systems, manually operated flocculation systems, residential-use flocculation systems, and filters for such systems. Systems, apparatuses, and methods consistent with those disclosed herein clarify water in a hand-portable vessel by causing particles (e.g., dirt, dust, sediment, food particles, lint, etc.) to form flocs, and then trapping the flocs and debris using a floc filter. For example, the exemplary flocculation systems and filters disclosed herein can be used to clarify water in a mop bucket. By trapping the flocs, the flocculation systems and filters disclosed herein conserve resources by extending the useable life of water and cleaning products (e.g., soap or detergent) contained therein. Additionally, the exemplary flocculation systems and filters prevent, reduce, or ameliorate the fouling of cleaning tools (e.g., mops, sponges, rags, brushes, and the like) by dirt, debris, flocs, and the like in the water.

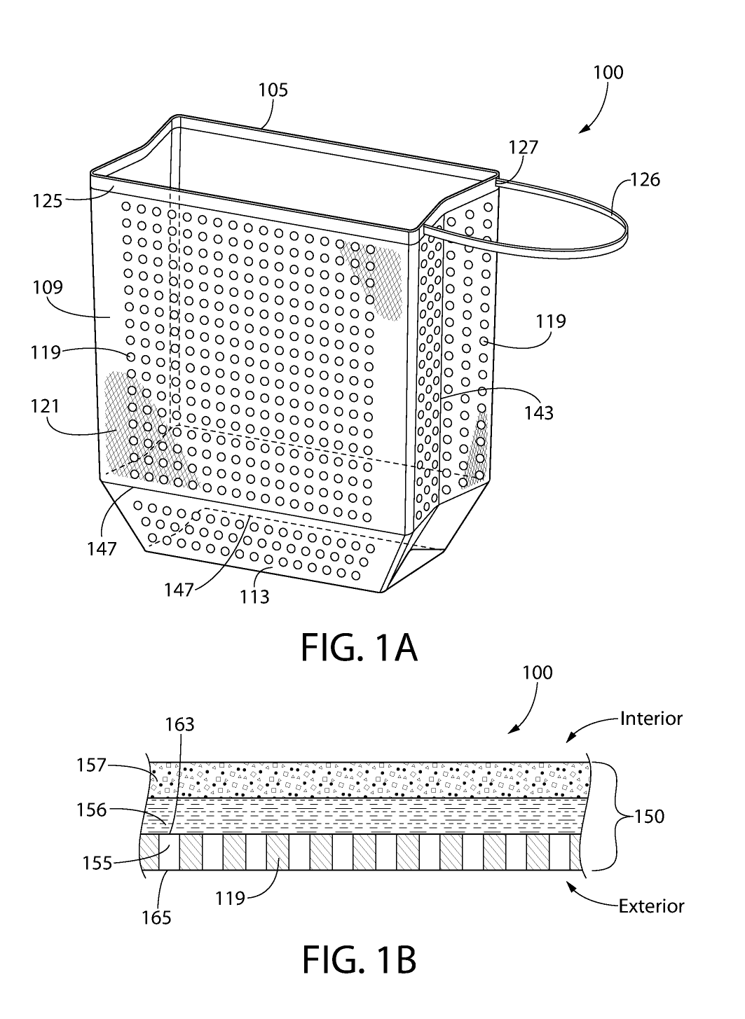

FIG. 1A illustrates a side perspective view of an exemplary flocculation filter 100 in accordance with aspects of the present disclosure. In implementations, the flocculation filter 100 is a vessel (e.g., bucket, pouch, or cup) having an open top 105, a sidewall 109, and a closed bottom 113. The sidewall 109 and/or the bottom 113 can be constructed from a woven or non-woven filter material including a large number of openings or holes 119 that are sized to trap flocs and other debris, while allowing water to pass out of or through the flocculation filter 100 and into, for example, a bucket or similar vessel. The filter material of the sidewall 109 and/or the bottom 113 can be a rigid, a semi-rigid, or a flexible material. In some implementations, such material can be water-impermeable, such as metal, rubber, silicon, plastic, vinyl, TYVEK, or the like. In other implementations, the filter material of the sidewall 109 and/or the bottom 113 can be water-permeable, such as a geotextile fabric or a cellulose mesh. In various implementations the holes or openings 119 range in size from about 0.03 inches to about 0.25 inches across (e.g., per side for square holes, in diameter for round holes, or effective opening size for meshes). In some configurations, the holes or openings 119 range in size from about 0.03 inches to about 0.12 inches across. For example, the openings 119 can range in size from about 0.03 inches to about 0.06 inches.

Additionally, in accordance with aspects of the present disclosure, an interior surface of the sidewall 109 and/or the bottom 113 can include a flocculant 121 that releases from the sidewall 109 and/or the bottom 109 when exposed to water. The flocculant 121 can be, for example, AJAX CLEAN WATER from the Colgate-Palmolive company of New York, N.Y. or the like.

In implementations a top edge of the sidewall 109, which forms the open top 105 of the flocculating filter 100, includes a releasable coupler 125 for attaching or mounting the flocculation filter 100 to other devices, such as flocculation system or a bucket. In some configurations, the coupler 125 can be or include a drawstring 126, an elastic band, or the like, which is captured in a tubular channel 127 around the top 105 of the flocculation filter 100.

Further, in some in implementations the flocculation filter 100 can be collapsible into a flat form for display, transport, and/or storage. In some configurations, the sidewall 109 of the flocculation device 100 includes one or more vertical fold lines 143 along which the sidewall 109 can collapse accordion-style. Also, the sidewall 109 and can include one or more horizontal fold lines 147 along which the bottom 113 can fold flat against the sidewall 109.

In a usage example consistent with aspects of the present disclosure, the flocculation filter 100 can be used in conjunction with a flocculation system (not shown) mounted to a mop bucket (not shown). See application Ser. No. ______ filed ______ titled, “Bucket for Wastewater Filtration” (Attny. Dkt. No. CP-11131-HCP), for examples of flocculation systems. A user performing a cleaning job using the flocculation system can obtain and store the flocculation filter 100 in the flattened form. For use, the user can expand the flocculation filter 100 into the configuration shown in FIG. 1A and attach it a corresponding support structure of a flocculation system using the coupler 125. For example, the user can fasten the coupler 125 around a mount (e.g., a lip) provided on the flocculation system using the drawstring 126. Alternatively, the user can insert the flocculation filter 100 into a cup provided by the flocculation system, fold the top 105 over the outside of the cup, and affix the flocculation filter 100 to the cup by tightening the drawstring 126. After mounting the flocculation filter 100, the user can wring-out a mop or other cleaning tool into the flocculation system, which can direct the flow of dirty water and debris from the mop into to the interior of the flocculation filter 100. The water causes the flocculant 119 on the sidewall 109 and/or the bottom 113 of the flocculation device 100 to release (e.g., dissolve into the water). In turn, the flocculant 119 causes the dirt and other particles in the water to form flocs. The holes or openings 119 in the flocculation filter 100 allow the water to pass through the sidewall 109 and/or the bottom 113 into the bucket, while trapping the flocs and other debris wrung from the mop. Accordingly, the flocculation filter 100 prevents spoliation of water in the bucket with the flocs, dirt, and debris. After the cleaning job is complete, the user can dispose of the flocculant filter 100. For the next cleaning job, the user can reuse the water in the bucket with another flocculation filter 100.

FIG. 1B illustrates a cutaway side view of a wall 150 of the exemplary flocculation filter 100 in accordance with aspects of the present disclosure. In implementations, the wall 150 includes a filter layer 155 (e.g., sidewall 109, bottom 113) and a flocculant layer 156 (e.g., flocculant 121), which can be the same or similar to those described above. The filter layer 155 includes a large number of holes or openings 119 passing completely through its interior surface 163 and exterior surface 165. The flocculant layer 156 can be formed directly on the interior surface 163 of the filter layer 155. For example, in some configurations the flocculant layer 156 can be a sheet laminated onto the interior surface 163 of the filter layer 155. In other configurations, the flocculant layer 156 can be a spray or a drip-coating applied to the interior surface 163. In some implementations, the flocculant layer 156 may partially cover the layer, for example, in the form of stripes, swirls, or the like. Additionally, in some implementations, the wall 150 can include a third, innermost water-soluble layer 157 (e.g., gelatin) that provides a protective covering for the flocculant layer 156.

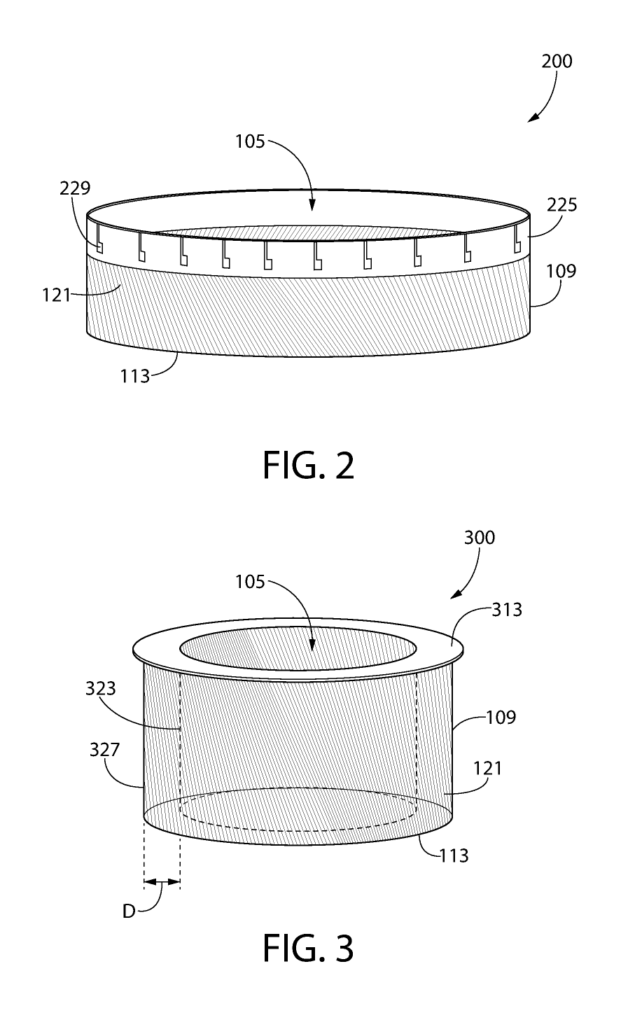

FIG. 2 illustrates a side perspective view of a flocculation filter or device 200 in accordance with aspects of the present disclosure. In implementations, the flocculation device 200 has a cup-shape, including an open top 105, a sidewall 109, a bottom 113, and a flocculant 121, which can be similar to those described previously herein. Additionally, the flocculation filter 200 includes a coupler 225 comprised of a rigid collar for mechanically interlocking the flocculation filter 200 to a corresponding mount on a flocculation system (e.g., a bucket mounted mop strainer). The coupler 225 may include one or more mechanical interlocking elements 229 that form a secure and/or substantially water-tight seal with the mount. For example, in some configurations, the one or more mechanical interlocking elements 229 can be threads (e.g., quarter-turn threads) that mate with corresponding threads on the mount. In other configurations, the one or more mechanical interlocking elements 229 can be snap-fit couplers. In still other configurations, the mechanical interlocking elements 229 may be L-shaped slots (as shown in FIG. 2) that mate with corresponding lugs on the mount. It is understood that other mechanical interlocking mechanisms can be used.

FIG. 3 illustrates a side perspective view of a flocculation filter 300 in accordance with aspects of the present disclosure. In implementations, the flocculation filter 300 comprises a vessel having a substantially cylindrical shape (e.g., cup-shaped) including an open top 105, a sidewall 109, a closed bottom 113, and a flocculant 121, which can be the same or similar to those previously described herein. Additionally, the flocculation filter 300 can include a retaining lip 313 around an uppermost edge of the top 105. Further, the sidewall 109 and/or the bottom 113 can be formed from the same materials previously described herein. In some implementations, the sidewall 109 and/or the bottom 113 have an interior wall 323 and an exterior wall 327 separated by a distance D. The distance D can be between one-quarter (0.25) inch and about one-half (0.5) inch. The space between the interior wall 323 and the exterior wall 327 can be partially or entirely filled with the flocculant 121, such as that previously described herein. For example, the space can be filled with a porous mesh material (e.g., a cellulose mesh) that is coated or impregnated with the flocculant 121.

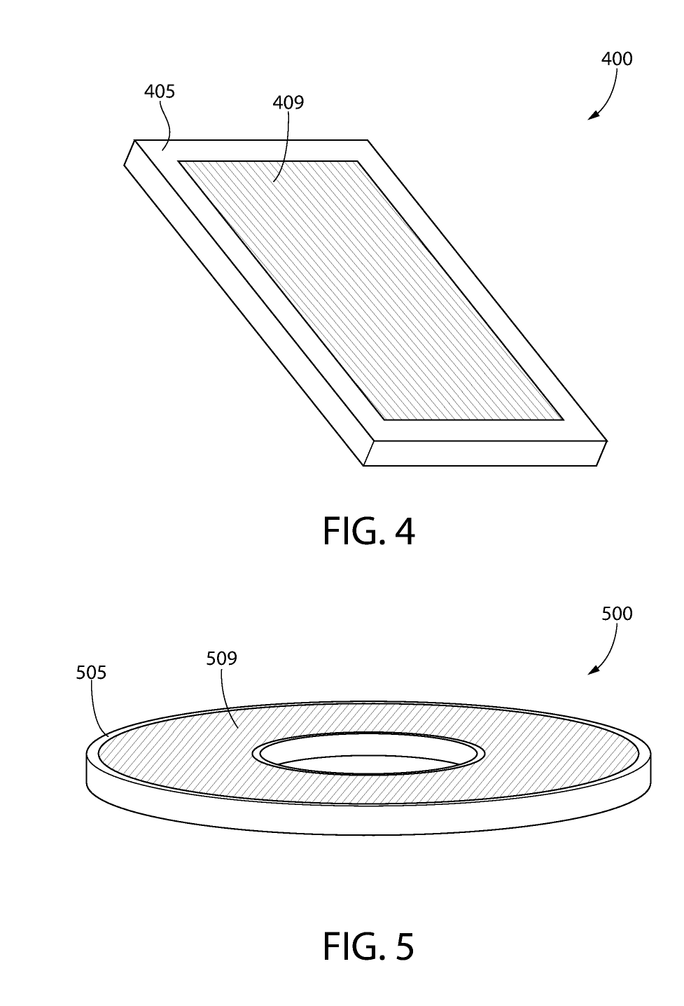

FIG. 4 illustrates a side perspective view of a flocculation filter 400 in accordance with aspects of the present disclosure. In implementations, the flocculation filter 400 includes a frame 405 having a substantially flat shape surrounding or otherwise supporting a filter material 409. The frame 405 can be comprised of a rigid or semi-rigid material (e.g., metal or plastic). The filter material 409 can be the same as those previously described herein (e.g., wall 150). Additionally, while the flocculation filter 400 is illustrated as a rectangular shape, it is understood that the flocculation filter 400 can have other shapes (e.g., square, semicircular, circular, etc.).

FIG. 5 illustrates a side perspective view of a flocculation filter 500 in accordance with aspects of the present disclosure. In implementations, the flocculation filter 500 is a substantially flat, circular shape having a frame 505 that surrounds or otherwise supports a filter material 509. For example, the filter 500 can have a toroidal shape, wherein the frame 505 can circumscribe the outer edges and the inner edges of the toroid. The frame 505 and the filter material 509 can otherwise be similar to those previously described herein (e.g., frame 405 and filter material 409 formed of a wall 150).

The above features have been described in detail with particular reference to certain preferred embodiments thereof, but it will be understood that variations and modifications can be effected within the spirit and scope of the disclosure. One of skill in the art will appreciate that each of the above are exemplary implementations and are not to be construed as a limitation on the scope of the present disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in any ensuing claims are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A flocculation filter comprising:
a vessel including a sidewall, a closed bottom, and an open top, said open top separated from said closed bottom by said sidewall, wherein each of the sidewall and the closed bottom is formed as a filter layer including a plurality of openings configured to pass water and trap flocs; and
a flocculant layer disposed on at least a portion of one or both of the closed bottom and sidewall, said flocculant layer comprising a flocculant;
wherein said open top is defined as a single opening which is open to the vessel and is defined on its sides by edges of the sidewall.

2. The flocculation filter of claim 1, further comprising a water-soluble layer disposed on the flocculant layer.

3. The flocculation filter of claim 1, wherein the filter layer comprises a woven material.

4. The flocculation filter of claim 1, wherein the filter layer comprises a non-woven material.

5. The flocculation filter of claim 1, wherein the filter layer is a flexible material.

6. The flocculation filter of any of claim 1, wherein the filter layer is a rigid material.

7. The flocculation filter of claim 1 wherein the plurality of openings range in size from about 0.03 inches to about 0.25 inches across.

8. (canceled)

9. The flocculation filter of claim 1, wherein an edge of the sidewall at the open top comprises a coupler.

10. The flocculation filter of claim 9, wherein said sidewall comprises an interior wall and an exterior wall separated by a tubular channel, wherein the coupler comprises a drawstring or an elastic band captured in said tubular channel.

11. The flocculation filter of claim 9, wherein the coupler comprises a rigid collar including one or more mechanical interlocking elements.

12. The flocculation filter of claim 11, wherein the one or more mechanical interlocking elements comprise threads or L-shaped slots.

13. The flocculation filter of claim 11, wherein the one or more mechanical interlocking elements comprises a snap-fit coupler.

14. The flocculation filter of claim 1, wherein the filter layer comprises an interior wall and an exterior wall separated by a distance defining a space.

15. The flocculation filter of claim 14, wherein the distance between the interior wall and the exterior wall is between about one-quarter inch to about one-half inch.

16. The flocculation filter of claim 14, wherein the space is filled with a mesh material and the mesh material is the flocculant layer and is coated or impregnated with said flocculant.

17. The flocculation filter of claim 1, further comprising a frame having a substantially flat shape that supports the filter layer.

18. The flocculation filter of claim 17, wherein the frame is rectangular.

19. The flocculation filter of claim 17, wherein the frame is circular.

20. The flocculation filter of claim 17, wherein the frame is toroidal.

21. The flocculation filter of claim 1, wherein said vessel is movable between an expanded configuration during use and is collapsible into a reduced profile configuration by folding said sidewall.

22. The flocculation filter of claim 21, wherein said sidewall comprises a fold line along which the filter layer is folded.

23. The flocculation filter of claim 1, wherein said openings are formed in the sidewall and the closed bottom.

24. The flocculation filter of claim 2, wherein the water-soluble layer is formed from gelatin.
